(19) United States
(12) Patent Application Publication
(10) Pub. No.: US 2004/0178612 A1
(43) Pub. Date: Sep. 16, 2004

(54) Advanced weight responsive supplemental restraint computer system

(76) Inventor: Joseph Akwo Tabe, Silver Spring, MD (US)

Correspondence Address: David A. Lundy, KRIEG DEVAULT LUNDY LLP., 825 Anthony Wayne Bldg., 203 E. Berry St., Fort Wayne, IN, 46802, US

(21) Appl. No.: 10/680,826

(22) Filed: Oct. 7, 2003

Related U.S. Application Data
(63) Continuation-in-part of application No. 09/692,096, filed on Oct. 20, 2000, now abandoned.

(51) Int. Cl. B60R 21/32

(52) U.S. Cl. 280/735; 180/273

(57) ABSTRACT

An improved restraint system for a vehicle comprises a weight-sensing unit mounted to one or more seats for sensing the weight of a sitting occupant, a computerized system for calculating an operating weight value corresponding to that weight, and an airbag system comprising one or more airbags and a deployment unit, the deployment unit configured to inflate the airbags with a deployment force and acceleration proportionate to the operating weight value when a sufficient collision force is sensed by a collision sensor.

This application is a Continuation-In-Part of application Ser. No. 09/692,096, filed on Oct. 20, 2000. Applicant hereby claims priority under 35 U.S.C. 119 of U.S. Provisional Application, Serial No. 60/052,435 filed Jul. 14, 1997, U.S. patent application Ser. No. 08/953,503 filed Oct. 17, 1997, U.S. Provisional Application Serial No. 60/079,496 filed Mar. 26, 1998, World Intellectual Property Organization Application Number WO 99/48729 and Patent Cooperation Treaty Application Serial Number US99/06666.

### BRIEF DESCRIPTION OF THE DRAWINGS

FIG. 1 shows a diagrammatic view of an occupant in a seat in a vehicle employing the present invention;

FIG. 2 shows a cross-sectional side view of a load cell as a weight sensing unit according to the present invention;

FIG. 3 shows a diagrammatic view of a computerized system according to the present invention;

FIG. 4 shows a diagrammatic side cut-away view of an airbag system according to the present invention,

FIG. 5 shows another version of the present invention further comprising a smart seat belt system;

FIG. 6 shows another version of a weight sensing unit comprising an inflatable or deflatable bag and a device for recording and transmitting values for inflation or deflation of the

FIG. 7 shows a diagrammatic view of the present invention comprising seat belt sensors and airbag sensors for controlling the direction of airbag deployment away from an occupant's head; and

FIG. 8 shows a side cross-sectional view of one version of an airbag used with the present invention.

### DETAILED DESCRIPTION OF EMBODIMENTS OF THE INVENTION

The improved supplemental restraint system 10, according to the present invention comprises one or more weight-sensing units 12 operatively secured beneath one or more seats 14 in a vehicle (not shown), the units being communicatively connected to the vehicle's supplemental restraint system via a computerized system 16 that intelligently controls the deployment force and acceleration used to inflate airbags 18 corresponding to each seat occupied by an occupant 20. The weight sensing units 12 are configured to take weight or mass measurements of an occupant 20 in a seat 14, convert the weight measured into a corresponding electrical signal, and communicate the electrical signal to the computerized system 16. Electrical signals, pursuant to the present invention, are based on weight or mass measurements taken so that deployment of airbags 18 is intelligently controlled and ultimately based on the weight measurements. In this way, the deployment force for each airbag 18 is determined proportionately based on the weight or mass of the occupant 20 occupying the corresponding seat. Other features of the present invention may include the storage and use of other information regarding occupants in the vehicle, such as whether seatbelts 22 are buckled and whether arms and legs are in proper safety enhancing positions.

It will be understood and appreciated by those of ordinary skill in the art that the system 10 described herein may measure, calculate and/or utilize either weight measurements or mass values pertaining to an occupant, so long as deployment force and acceleration of airbags is ultimately based on either or both of the weight measurements or mass values, and this disclosure treats weight and mass as equivalents for achieving the objectives of the system 10. Reference to weight one shall be interpreted as optionally referring to mass.

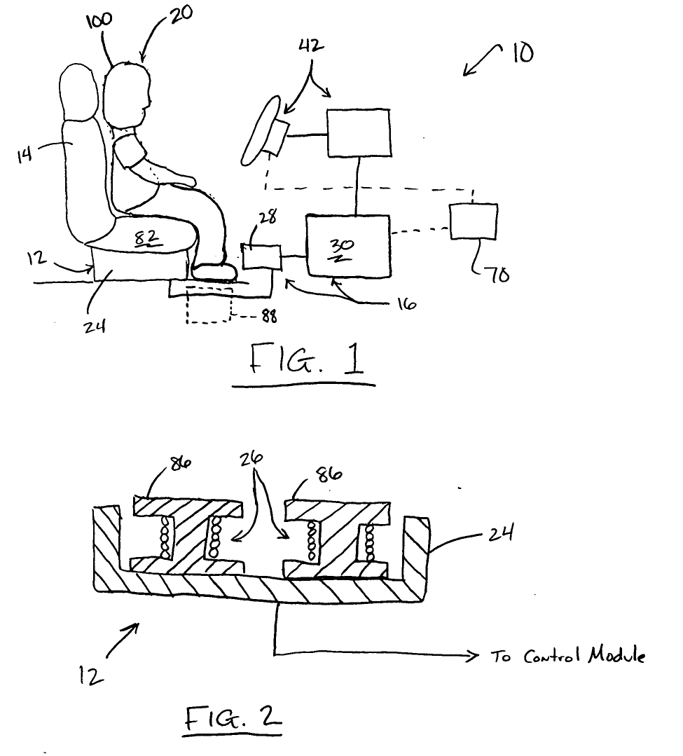

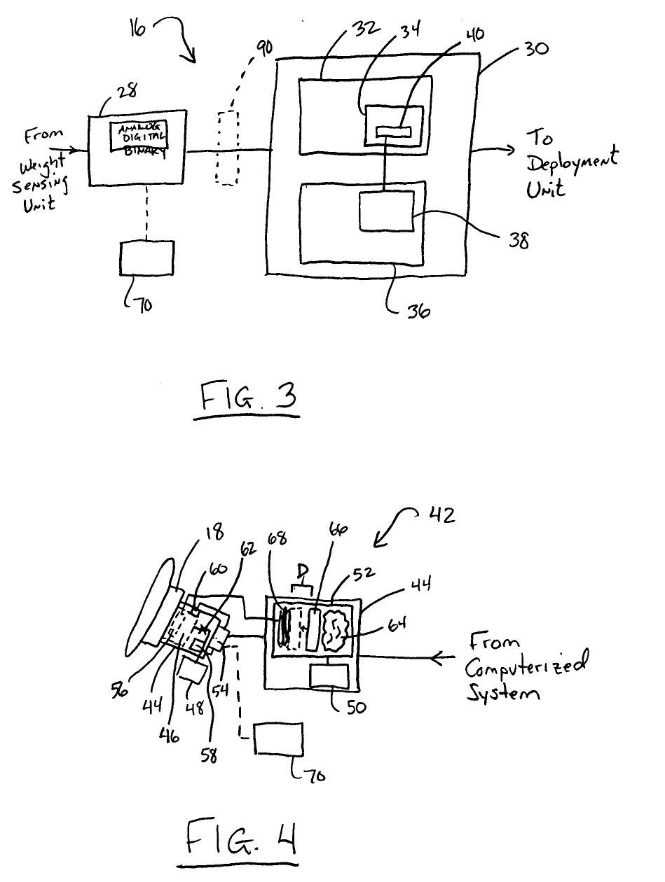

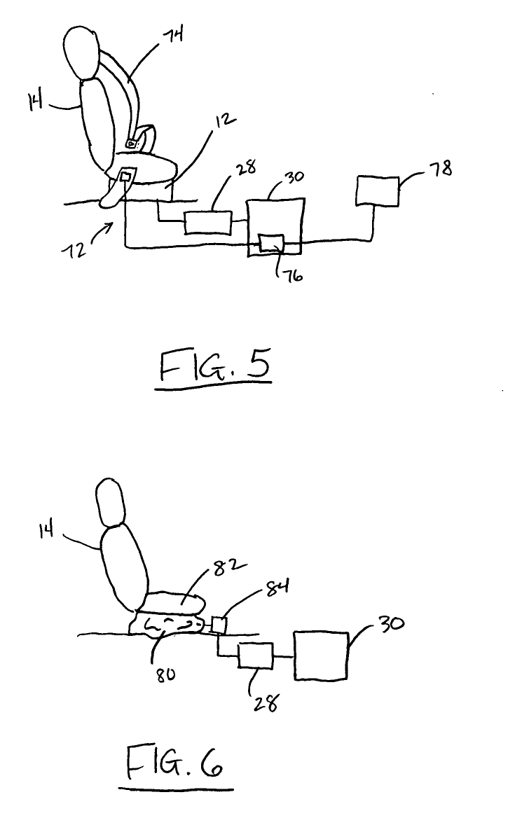

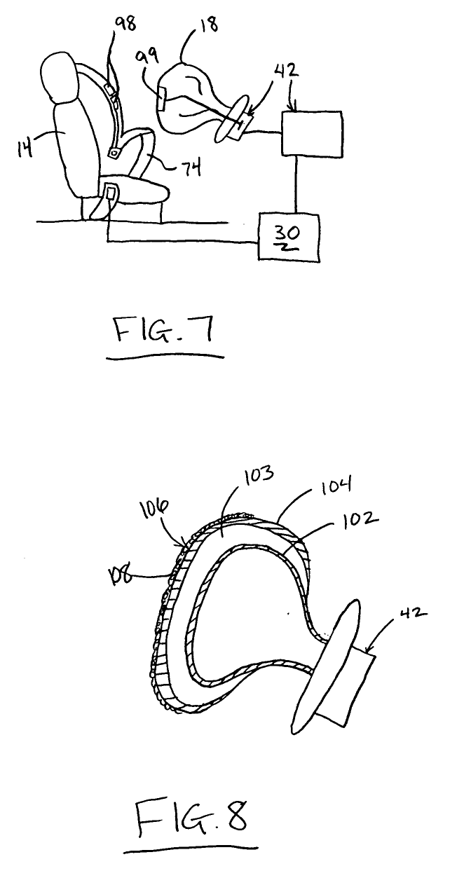

FIG. 1 shows an occupant 20 sitting in a seat 14. In one embodiment, the weight-sensing unit 12 comprises a load cell 24 secured beneath the seat 14. In other embodiments, more than one load cell 24 is secured beneath the seat 14. Each load cell 24 comprises one or more strain gauges 26 that are configured to sense a force applied to them when an occupant 20 sits on the seat 14. The strain caused by the force of the occupant 20 on the seat is measured by the gauge 26 which delivers an electrical line signal to the computerized system 16 for processing in accordance with the present invention.

In one embodiment, the computerized system 16 comprises a control module 28 electronically connected to a central processing unit (CPU) 30. A control module 28 receives the electrical line signals from each load cell 24 and identifies particular seats 14 in the vehicle from which signals are received. As a result, in one embodiment, the control module 28 categorizes data received as pertaining to functionality of one or a set of airbags 18 corresponding to a particular seat 14 in the vehicle. Similarly, in other embodiments, the control module 28 categorizes data as being insufficient for activating one or a set of airbags 18 corresponding to a seat 14 because there is no occupant 20 for that seat or because a small child is the occupant. In yet other embodiments, the control module 28 will only activate airbags 18 for a seat 14 in which the load cells 24 detect an occupant 20 over about 20 lbs.

In one embodiment, the control module 28 receives electrical line signals from load cells 24 as analog signals. In other embodiments, the control module converts analog signals it receives into digital signals. In yet other embodiments, the digital signals are converted into binary signals for using a plurality of transistorized switches (not shown) for processing weight value data and communicating such data to the various electronic and computer components in the system 10.

The control module 28 delivers data from load cells 24 to the CPU 30 which comprises read only memory (ROM) 32 that has a basic input output system (BIOS) 34. The CPU 30 also comprises random access memory (RAM) 36 used to run at least one software program 38 in the CPU 30 configured for calculating occupant weight values. The BIOS 34 stores the load cell data as a weight measurement in an address line 40 in the BIOS. The RAM 36 runs the software program 38 to access the address line 40 to obtain the weight measurement and communicates it to the software program 38 in the CPU 30 that calculates and confirms the weight measurement, and determines the operating weight value for the occupant 20 in each seat 14.

The operating weight value is then communicated to the airbag system 42 corresponding to the seat 14. In one embodiment, the airbag system 42 comprises one or more airbags 18 operatively connected to a deployment unit 44. In other versions, the deployment unit 44 comprises a combustion chamber 46 that is operatively connected to a canister 48 of igniting gas. In the present invention, the airbag system 42 further comprises a microprocessor 50 electrically connected to an accelerometer 52 that is electrically connected to a canister microprocessor 54 and operatively connected to a sliding pot 56. The canister microprocessor 54 is electrically connected to a gas release valve relay 58 and an igniter 60. The sliding pot 56 is operatively connected to the combustion chamber 46. The release valve relay 58 is operatively connected to a release valve 62 between the gas canister 48 and the combustion chamber 46.

The operating weight value is received within the airbag system 42 by the microprocessor 50. The microprocessor 50 delivers a signal corresponding to the operating weight value to the accelerometer 52, which translates that signal to a corresponding proportionate electric current that energizes the piezoelectric crystals 64 in the accelerometer 52. In this way, the accelerometer is used in reverse to its normal function. The energy from the crystals 64 is thus also proportionate to the operating weight value, which represents the weight of the occupant 20 in the seat 14. The electrical energy from the crystals 64 is converted to mechanical energy and employed to displace the mass 66 in the accelerometer 52 the distance D directly related to the crystal energy. The mass 66 abuts a spring 68 which is correspondingly compressed by the displacement of the mass an amount directly related to the distance D. The spring compression is thus directly related to the crystal energy which is directly related to the operating weight value which is based on the weight of the occupant 20 in the seat 14.

The compression of the spring 68 is the culmination of translating the electrical energy of the current applied to the crystals 64 into the mechanical energy applied to the sliding pot 56 to adjust the opening in the combustion chamber 46 for the gas to expand into the airbag 18 when ignited. In conjunction with this adjustment, the canister microprocessor 54 receives the same signal from the microprocessor 50 that is delivered to the accelerometer 52 that corresponds to the operating weight value. The canister microprocessor 54 utilizes this signal to communicate to the gas release valve relay 58 a specific volume of the gas (not shown) to be released through the release valve 62 into the combustion chamber 46.

The sliding pot 56 position and the volume of the gas released are calibrated together such that the particular position and the particular volume released generate a specific deployment force and acceleration when the gas is ignited by the igniter 60 when the igniter receives a signal from a collision sensor 70 that a collision has occurred that requires airbag deployment. Because each of the gas release valve relay 58 and the accelerometer 52 (which operatively adjusts the position of the sliding pot 56) are operated according to signals corresponding to the operating weight value that is based on the weight of the occupant 20 in the seat 14, the deployment force then corresponds directly to the weight of the occupant in the seat as well in order to optimize the safety of airbag deployment and reduce injuries to occupants as a result.

In one version, a collision sensor 70 signals the control module 28 when a minimum threshold collision severity has occurred in order to start the supplemental restraint system process according to the present invention. In other versions, the minimum threshold collision severity comprise a collision substantially equivalent to a vehicle traveling between about 10 m.p.h. and about 15 m.p.h. and hitting a substantially rigid wall (not shown). In yet other versions, the collision sensor 70 signals the canister microprocessor 54 directly or the igniter 60 directly to initiate the ignition of the proportionate volume of gas released into the combustion chamber 46. In the latter case, the system 10 of the present invention prepares the sliding pot 56 position and volume of igniting gas in advance when the operating weight value is determined from the weight of the occupant 20 on the seat 14. In yet other embodiments, the collision sensor 70 only signals a collision event has occurred when the collision exceeds predetermined speed and collision force thresholds for deployment of the airbags 18, so that deployment depends on collision severity.

In one version, the ROM 32 comprises a portion that is erasable and programmable (EPROM). The EPROM erases the data in the address line 40 in the BIOS 34 for a particular seat 14 every time an occupant 20 leaves a seat. The EPROM then replaces the data with new data when the occupant or a new occupant takes the seat.

In one version, the system 10 of the present invention is used in conjunction with a smart seatbelt system 72. In other versions, the smart seatbelt system 72 will prevent the vehicle from starting unless one or all occupants 20 are wearing their seatbelts 74. If the occupants 20 decide to put on the seatbelts 74 simply to start the vehicle, as soon as the seatbelts are disconnected, the engine (not shown) will shut off. As a result, the engine will stay running only when all of the seatbelts 74 are worn in all of the occupied seats 14. In another version, the smart seatbelt system 72 will not allow disconnection of the seatbelt 74 in any way or form unless the engine is first turned off. In this way, a seatbelt processor 76 in the CPU 30 will monitor seatbelt disconnection processes and disable the vehicle's starting means 78 when an occupant 20 is not belted. In yet other embodiments, if a driver decides to stop and pick up another occupant with the engine running, or if the occupant enters the car and fails to put on the seatbelt, the seatbelt processor 76 will deliver a signal to the vehicle starting means 78 to shut the vehicle engine off. The vehicle will only be able to restart when the occupants buckle their seatbelts.

The load cells 24 or other sensors (not shown) in the vehicle can measure additional data relevant to occupants 20 in a vehicle. For example, in one version, sensors are installed inside the vehicle in various locations to sense the position of the occupants 20 within their respective seats 14 or the positions of the respective occupant's arms and legs, such as propped up on the dashboard (not shown). This data may be processed and stored in the CPU 30. In other embodiments, the CPU 30 may signal a driver of the vehicle regarding unsafe conditions or behavior resulting from different occupant's unsafe body positions. In yet other versions, such signals comprise a verbal report. In yet other versions, the vehicle is disabled after a preset time until such unsafe behavior or positioning is corrected.

In one version, a weight sensing unit 12 alternative configuration comprises a pressurized, inflatable or inflated bag 80 mounted in the cushion 82 of the seat 14 or beneath the seat. When an occupant 20 occupies a seat 14, the weight of the occupant will either displace a certain amount of the stored pressure in such bag 80 to a relay valve 84 or initiate the inflatable bag 80 to inflate that specific amount of air to the relay valve 84 that will record the displacement or inflation, as the case may be, as the occupant's weight value. The displaced pressure or the inflated air pressure is the maximum pressure that, when the collision sensor 70 senses a collision, it will signal the accelerometer 52 which then initiates the deployment speed and force of the airbags 18 to correspond to the displaced pressure or the inflation pressure from the bag 80. The displaced or inflation pressure is the maximum pressure for the maximum acceleration in deployment force of the airbags 18 that may be deployed when the collision sensor 70 senses a sufficient collision force. When the occupant 20 leaves the seat, the weight removed will displace stored pressure or allow reinflation of a deflated bag 80 that is equal to the weight value of the occupant 20. If the weight value matches or exceeds the stored pressure, then the acceleration and deployment force will have a constant value when a collision is sensed. The displacement or inflation recorded by the relay valve 84 will be transformed into a weight unit for the CPU 30 to recognize. The CPU 30 will then carry on the calculations and computations according to the present invention the same way as for the conventional load cell 24 configuration. In light of the foregoing, alternative means for measuring weight values and communicating them to the CPU 30 are also within the scope of the present invention, which is not intended to be limited by the specific description of a load cell 24 or the above alternative inflatable bag 80 configuration therefor.

In operation, when the ignition switch (not shown) for the vehicle is turned on, an electrical current of 5 milivolts will power the load cell 24 prior to the CPU 30. When an occupant 20 occupies any of the seats 14 in the vehicle, the load cell 24 or cells for each seat 14 will read the energy from the weight input from the occupant 20 in the seat 14 to communicate with the CPU 30 to enable data processing and computation. The CPU 30, once powered, runs functions that check all of the hardware components functionality to ensure that they are functioning properly. The CPU 30 comprises a computer chip motherboard (not shown) that contains the CPU operating components 32, 34, 36, 76, etc. Once the CPU 30 conducts its system functionality check, a boot program (not shown) then checks to see if any occupants 20 have occupied any of the seats 14. The boot program does this by searching for signals output from the load cell 24. The boot program then sends the information from the load cells 24 to the address line 40 in the BIOS 34. The 5 milivolt current from the power source (not shown) of the vehicle is used to generate the electrical line signals that are communicated back and forth between the components of the present invention. Components such as the strain gauges 26 and the accelerometer crystals 64 being electrical resistance elements, the current used to convey the electrical line signals is thus manipulated as a result of the increase or decrease in the resistance of these elements when current or strain is applied.

In one version, a load cell 24 comprises a corrosion resistant, high alloy steel construction. In yet other versions, a load cell 24 comprises a weight measuring capacity of up to about 1,000 lbs. In yet other versions, a load cell 24 comprises machined, high steel beams 86 having strain gauges 26 secured thereto. In yet other versions, the strain gauges 26 comprise electrical resistance elements sealed with a sealant (not shown) to prevent moisture or contaminants from disrupting strain measuring functions.

In one version, a control module 28 comprises a silicon control rectifier that manages flow of data to the ROM 32 in the CPU 30. In other versions, the data comprises occupant weight information and other in-vehicle information regarding the occupant 20. The CPU 30 comprises a ROM 32 having EPROM capabilities as well as a BIOS 34, and the CPU 30 further comprises RAM 36 and a software program 38 running within the RAM. The CPU 30 records information regarding the occupant 20, including how the occupant changes positions or shifts weight in the seat 14. The BIOS 34 comprises the basic control over the load cell 24 data stored in the ROM 32. The ROM contains a special chip (not shown) for the CPU 30 that contains instructions and other information that is not erasable or reprogrammable during the life of the CPU. The RAM 36 comprises the primary memory storage for running the software program 38 that accesses the occupant's information and allows the CPU 30 to calculate the operating weight value, among other data for use in accordance with the present invention.

In one version, a signal amplifier 88 is employed for amplifying the electronic signals delivered from one component of the system 10 to the others.

Although the present invention is designed for use with a supplemental restraint system that utilizes a combustible gas for generating the force and volume for inflating an airbag, it is within the scope of a person or ordinary skill in the art to modify the present invention for use with a standard supplemental restraint system that utilizes a sodium azide/potassium nitrate reaction for producing hot and fast blasts of nitrogen gas to inflate the airbag. The solid propellant from the standard supplemental restraint system can be volumetrically controlled for release into a combustion chamber in amounts required for a deployment force and acceleration corresponding to the weight of an occupant 20 in a seat 14.

In one version, electronic line signals are delivered and received as binaries that communicate between transistorized switches (not shown) that read the 1s and 0s as “off” and “on” as required for the components of the present invention to effectively communicate data back and forth. In other versions, a transient voltage suppressor 90 may be located between the control module 28 and the address line 40 within the CPU 30. In the event of a transient voltage spike to the system 10 which would cause abnormal readings or reactions for the RAM 36, a voltage suppressor 90 may be utilized to filter out transient spike phenomenon and ensure that accurate weight values are retained. With regard to binary signals, an “off” signal represents an open circuit and an “on” signal represents a closed circuit. Binary signals will logically be used to tell the CPU 30 the number of switches that need to be turned off and on to influence accurate responses to the operating weight values. Also, use of binaries will enable to the CPU 30 to activate devices that will initiate controlled energies toward the smart deployment of airbags 18 without causing injuries to occupant 20. The CPU 30 uses logical functions to timely open and close all circuits within the transistorized switches. The logic depends on the switches to open and close on time for the system 10 to know the weight of the occupant 20 before activating the deployment force of the airbag 18. The binary number system will allow the CPU 30 to do any other form of math. Everything in the CPU 30, math, words, decimal numbers and software instructions, will communicate in the binary numbers. This means that the transistorized switches can do all types of manipulation. The clock (not shown) inside the CPU 30 regulates how fast the CPU should work, or how fast the transistorized switches should open or close. The faster the clock ticks or emits pulses, the faster the CPU will work. The speed is measured in gigahertz, which is billions of ticks per second. Electrical current passing through one transistorized switch may be used to control another transistorized switch, in effect turning the switch on and off to change what the second transistorized switch represents as a logic gate.

In one version, the system 10 further comprises one or more rear end collision sensors 92 mounted to the rear of the vehicle. In other versions, the rear end collision sensors 92 are configured for sensing a collision at the rear of the vehicle and electrically communicating to the computerized system 16 the severity of such a collision. In yet other versions, the computerized system 16 is further configured to receive and process the communication from the rear end collision sensors 92 and trigger deployment of the airbags 18 through the airbag systems 42 corresponding to each seat 14 occupied by an occupant 20. In yet other versions, each rear end collision sensor 92 comprises a radar unit 94 communicating with a radar receiver 96 operatively connected to the computerized system 16 for communicating rear end collision severity to the computerized system 16. In yet other versions, severity of a rear end collision sensed by said rear end collision sensor 92 is communicated by the computerized system 16 to the airbag system 42 which is further configured to process information corresponding to that severity to determine deployment force and acceleration for airbag inflation proportionate to said weight measurements and to the collision severity.

In one version, the system 10 further comprises one or more seat belt sensors 98 mounted to the seat belt 74 for at least one seat 14 in the vehicle and electrically connected to the computerized system 16, and corresponding airbag sensors 99 mounted to the airbag 18 and operatively connected to the air bag system 42 such that sensors 98 communicate with sensors 99 for purposes of approximating the location of the occupant's head 100, which is presumed to be at a point generally above the location of the seat belt sensor 98. Sensors 98 and 99 in one embodiment comprise thin proximity sensors or signal transmitter couplers that communicate with each other and generate solid state switch outputs when the sensing surfaces of the sensors 98 and 99 are near each other upon deployment of the airbag 18. As a result, the initial contact of the inflated airbag 18 with occupant 20 is approximately at the seat belt sensor 98 and the airbag sensor 99.

As shown in FIG. 8, in one version, at least one airbag 18 comprises a double-layer construction comprising an internal layer 102 configured for receiving inflation of the airbag 18, and an external layer 104 comprising a cushioned outer surface 106. In other versions, the cushioning for the outer surface 106 comprises polyurethane foam 108. In yet other versions, layers 102 and 104 define a deflatable air gap 103 between them which provides additional cushioning when an occupant 20 contacts the airbag 18 upon its deployment.

While various specific structural versions of the invention have been shown and described for purposes of illustration, the protection afforded by any patent which may issue upon this application is not strictly limited to the disclosed embodiments, but rather extends to all structures, arrangements and methods which fall fairly within the scope of the claims which are appended hereto: correspond to the substitute specification also submitted herewith. Reconsideration is respectfully requested.

Specification

The Examiner has objected to the specification of the application under 35 U.S.C. §112, first paragraph, for several reasons, including improper formatting and failure to be written in full, clear, concise and exact terms. A substitute specification completely replacing the specification currently pending is submitted herewith containing no new matter.

Furthermore, the Examiner has objected to Applicant's use of the art-recognized term “accelerometer” as inconsistent with the art-recognized definition. Applicant respectfully traverses the examiner's objection in that regard, because the specification describes the art-recognized structure for an accelerometer, and even though the use of the accelerometer in the context of Applicant's invention is not necessarily either commonly or uncommonly recognized in the art, the structure as described is indeed an accelerometer. Accelerometers can be described as a combination of two transducers—the primary transducer, typically a single-degree-of-freedom vibrating mass, or seismic mass, which converts the acceleration into a displacement, and a secondary transducer which converts the displacement of the seismic mass into an electric signal. Thus the use of the term is proper and the objection on this basis should be withdrawn. Reconsideration is respectfully requested.

Claim Rejections—§112

Claims 1-14 and 28-33 have been rejected under 35 U.S.C. §112 ¶¶1,2 for various reasons, including containing subject matter not described in the specification in a way to convey that Applicant was in possession of the claimed invention, containing subject matter not enabled by the specification, and containing indefinite and functional or operational language. These claims have been cancelled and new claims added, making the rejections moot. Moreover, the specification has been substituted with a new specification containing no new subject matter but which Applicant submits properly enables the added claims that the Applicant was in possession of the claimed invention at the time the application was filed. Reconsideration is respectfully requested.

For all of the reasons stated above, Applicant respectfully submits that the application as amended is in form for immediate allowance upon examination of the substitute specification and the newly submitted claims. Applicant respectfully solicits the prompt issuance of a Notice of Allowance.

34. An improved supplemental restraint system for a vehicle comprising: a weight-sensing unit operatively secured beneath at least one seat in said vehicle; a computerized system communicatively connecting said unit to a supplemental restraint system installed in said vehicle, said supplemental restraint system comprising at least one airbag system each having at least one airbag, each said airbag system corresponding to one of said seats; said weight-sensing unit being configured for taking weight measurements of an occupant in a said seat, converting said weight measurements into one or more electrical signals, and communicating said electrical signals to said computerized system; said computerized system being programmably configured to calculate an operating weight value from said electrical signals corresponding to said weight measurements for each said seat and to communicate said operating weight value to said airbag system corresponding to said seat; each said airbag system being electronically configured for receiving said operating weight value for said seat and for mechanically adjusting a deployment unit within said airbag system to deploy said at least one airbag with a deployment force and acceleration for airbag inflation that are proportionate to said weight measurements.

35. The improved supplemental restraint system of claim 34 wherein said weight sensing unit comprises a load cell.

36. The improved supplemental restraint system of claim 35 wherein said load cell comprises at least one strain gauge configured to sense a force applied to it when said occupant occupies said seat, each said gauge comprising electrical resistance elements configured to detect and measure resistance occurring when external strain is applied to said gauge, wherein said external strain corresponds to said force from said occupant and is converted into a corresponding electrical current for communicating said electrical signals.

37. The improved supplemental restraint system of claim 34 wherein said computerized system comprises a control module electronically connected to a central processing unit, said control module programmably configured to identify each said seat for which said weight measurements are taken and to activate said airbag system corresponding to each said seat for which said weight measurements exceed a minimum weight threshold value generally corresponding to the weight of a small child.

38. The improved supplemental restraint system of claim 37 wherein said minimum weight threshold value is about 20 pounds.

39. The improved supplemental restraint system of claim 37 wherein said control module is configured to receive analog electric line signals from said weight sensing unit regarding said weight measurements, said control module further being configured to convert said analog signals to digital signals corresponding to said analog signals.

40. The improved supplemental restraint system of claim 39 wherein said control module is further configured to convert said digital signals to binary signals corresponding to said analog signals and suitable for use with a plurality of transistorized switches that comprise said central processing unit for processing said weight measurements as said binary signals and communicating said operating weight value calculated therefrom.

41. The improved supplemental restraint system of claim 37 wherein said central processing unit comprises read only memory having a basic input-output system for storing said weight measurements communicated from said control module, said central processing unit further comprising random access memory, said read only memory storing a software program that utilizes said random access memory, said software program being programmed to use said random access memory for accessing said weight measurements from an address line in said basic input-output system and for calculating said operating weight value.

42. The improved supplemental restraint system of claim 34 wherein said deployment unit comprises a combustion chamber operatively connected to a canister of igniting gas, a microprocessor configured to receive said operating weight value communicated from said computerized system, said microprocessor electronically connected to an accelerometer, said accelerometer electronically connected to said canister and operatively connected to said combustion chamber.

43. The improved supplemental restraint system of claim 42 wherein said accelerometer is electronically connected to said canister by a canister microprocessor electronically connected to a gas release valve relay and an igniter, said gas release valve relay being connected to a release valve operatively connected to said canister between said canister and said combustion chamber.

44. The improved supplemental restraint system of claim 42 wherein said accelerometer comprises at least one piezoelectric crystal operatively connected to a mass in contact with a spring, said spring operatively connected to a sliding pot secured to said combustion chamber, said sliding pot configured to adjust an opening in said combustion chamber for expansion of ignited gas from said canister into said at least one airbag.

45. The improved supplemental restraint system in claim 44 wherein said microprocessor is configured to translate said operating weight value received from said computerized system into an electric current proportional to said weight measurements and to energize said at least one crystal with said proportional current, said energized crystal configured with said mass for translating energy of said proportional current to mechanical energy for displacing said mass and correspondingly compressing said spring for adjustment of said sliding pot a degree proportional to said weight measurements.

46. The improved supplemental restraint system of claim 43 wherein said accelerometer is configured to deliver a first signal corresponding to said operating weight value to said canister microprocessor, said canister microprocessor configured to process said first signal and deliver to said gas release valve relay a second signal corresponding to a specific volume of gas to be released from said canister through said release valve into said combustion chamber, said specific volume comprising the amount of said gas required to generate said deployment force and acceleration for airbag inflation that are proportionate to said weight measurements.

47. The improved supplemental restraint system of claim 46 wherein said accelerometer comprises at least one piezoelectric crystal operatively connected to a mass in contact with a spring, said spring operatively connected to a sliding pot secured to said combustion chamber, said sliding pot configured to adjust an opening in said combustion chamber for expansion of ignited gas from said canister into said at least one airbag, said specific volume of gas and said opening defined by said sliding pot are calibrated together such that said opening and said volume generate said deployment force and acceleration when said volume is ignited by said igniter when a collision sensor operatively connected to said vehicle senses a collision has occurred of a severity requiring airbag deployment.

48. The improved supplemental restraint system of claim 34 further comprising a collision sensor operatively connected to said computerized system.

49. The improved supplemental restraint system of claim 34 further comprising a collision sensor operatively connected to said deployment unit.

50. The improved supplemental restraint system of claim 48 or claim 49 wherein said collision sensor is configured to signal for deployment of airbags in response to a threshold collision severity.

51. The improved supplemental restraint system of claim 48 or claim 49 wherein said collision sensor is configured to signal for deployment of airbags in response to a threshold collision severity, said threshold collision severity comprising a collision substantially equivalent to said vehicle traveling between about 10 m.p.h. and about 15 m.p.h. and hitting a substantially rigid wall.

52. The improved supplemental restraint system of claim 34 wherein said computerized system is configured to temporarily store said weight measurements and erase said weight measurement for one said seat when said occupant leaves said seat and to store newly taken weight measurements when said occupant or a new occupant occupies said seat.

53. The improved supplemental restraint system of claim 34 further comprising a smart seat belt system having a seat belt processor within the computerized system configured to disable said vehicle from starting or running if one or more seat belts for said seats are not worn by an occupant in said seats.

54. The improved supplemental restraint system of claim 34 wherein said weight sensing unit comprises an inflatable bag mounted within a bottom cushion for said seat or mounted beneath said seat, said inflatable bag configured to inflate or deflate an amount corresponding to the weight of said occupant, a relay valve being operatively connected to said bag, said valve configured to measure and record the amount of deflation or inflation of said bag and to transform said amount into a weight measurement and communicate said weight measurement electronically to said computerized system.

55. The improved supplemental restraint system of claim 54 wherein said deployment force and acceleration corresponds to said amount of deflation or inflation of said bag.

56. The improved supplemental restraint system of claim 34 wherein said weight sensing unit comprises a weight measuring capacity of up to about 1,000 pounds.

57. The improved supplemental restraint system of claim 34 further comprising a signal amplifier, said amplifier configured to amplify at least one of analog, digital and binary electronic signals transmitted within said improved supplemental restraint system.

58. The improved supplemental restraint system of claim 34 further comprising a transient voltage suppressor electronically connected to the computerized system, said suppressor configured to filter or diminish transient voltage spikes that have potential for damage within the computerized system or to cause abnormal readings or communications within the computerized system.

59. The improved supplemental restraint system of claim 34 further comprising one or more rear end collision sensors mounted to the rear of said vehicle, said rear end collision sensors configured for sensing a collision at the rear of said vehicle and electrically communicating with said computerized system the severity of such a collision, said computerized system being further configured to receive and process such communication from said rear end collision sensors and trigger deployment of said airbag systems corresponding to each said seat occupied by a said occupant.

60. The improved supplemental restraint system of claim 59 wherein said rear end collision sensor comprises a radar unit, said radar unit communicating with a radar receiver operatively connected to said computerized system.

61. The improved supplemental restraint system of claim 59 wherein said computerized system is configured to communicate severity of a rear end collision sensed by said rear end collision sensor to said airbag system, said airbag system being further configured to process information corresponding to said severity to determine deployment force and acceleration for airbag inflation proportionate to said weight measurements and to said severity.

62. The improved supplemental restraint system of claim 34 wherein at least one said airbag comprises a double-layer construction, said construction comprising an internal layer configured for receiving inflation of said airbag, and an external layer comprising a cushioned outer surface, said internal layer and said external layer defining an air gap therebetween.

63. The improved supplemental restraint system of claim 34 further comprising at least one seat belt sensor mounted to a seat belt corresponding to one said seat, said seat belt sensor being electrically connected to said computerized system, and at least one corresponding airbag sensor mounted to said airbag and operatively connected to said airbag system, said seat belt sensors and said airbag sensors being configured to communicate with each other regarding the proximity of sensing surfaces on said seat belt sensor and said airbag sensor, said airbag system being configured to direct deployment of said airbag so that initial contact of an inflated said airbag against said occupant is approximately at said seat belt sensor and said airbag sensor.

64. The improved supplemental restraint system of claim 63 wherein said seat belt sensors and said airbag sensors comprise either proximity sensors or signal transmitter couplers, said sensors or couplers being configured to communicate with each other and generate solid state switch outputs when said sensing surfaces are near each other upon deployment of said airbag.
